(19) United States
(12) Patent Application Publication
(10) Pub. No.: US 2002/0186479 A1
(43) Pub. Date: Dec. 12, 2002

(54) Optical system

(76) Inventors: Armin Schoppach, Aalen (DE); Paul Kaufmann, Aalen (DE); Thomas Petasch, Aalen (DE); Walter Krenkel, Renningen (DE); Ralph Renz, Sindelfingen (DE)

Correspondence Address: M. Robert Kestenbaum, 11011 Bermuda Dunes NE, Albuquerque, NM, 87111, US

(21) Appl. No.: 10/047,150

(22) Filed: Jan. 14, 2002

(30) Foreign Application Priority Data
Jul. 15, 1999 (DE) 199 33 248.7

(51) Int. Cl. G02B 7/02

(52) U.S. Cl. 359/820; 359/819

(57) ABSTRACT

The invention relates to an optical system comprising at least one first and second optical element, whereby the optical elements are arranged at a predetermined distance from one another, using a mounting. The mounting comprises compensation elements for modifying the predetermined distance between a first optical element and a second optical element, according to the temperature. The optical system is a telescope and the distance between the primary mirror and the secondary mirror is modified according to the temperature.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to an optical system with at least a first and second optical element, the optical elements being arranged at a predetermined distance from each other by means of a mounting.

### TECHNICAL FIELD

A mirror telescope with a primary mirror and a secondary mirror, which are arranged spaced from each other by means of a mounting, is known from German Patent Document DE 39 40 924 A1, for example. The mounting includes a telescope tube of Zerodur®. Likewise, a securing star of Zerodur® is provided for the mounting of the secondary mirror, and is connected to the telescope tube.

The material Zerodur® is selected because of its low thermal expansion coefficient. An athermal behavior, particularly in the temperature range from 20° C. to −50° C., is desirable in telescopes for optical telecommunication which are used in space, since in such uses readjustment during use is practically impossible.

In particular, deformations of the mirror are disadvantageous, since a displacement of the focal point is associated with them. Also, such a displacement of the focal point results in a defocusing. A nearly athermal behavior is obtained by the use of Zerodur; however, it is disadvantageous that this ceramic material is very brittle and only be handled or loaded to a small extent.

Furthermore, invar is used as a material in telescopes. However, this material has a considerable thermal expansion coefficient, so that the telescope has a temperature-dependent behavior.

The production of a mirror blank by a casting technique is known from German Patent Document DE 43 26 762 A. Silicon carbide is intended as the material.

It is known from U.S. Pat. No. 5,579,333 to use ceramics of silicon nitride (Si₃N₄) for the production of industrial mirrors.

Undesirable thermal effects also occur in objectives for semiconductor lithography. The optical properties of the respective components, such as mirrors and lenses, change due to heating; in particular, the focal length changes.

### SUMMARY OF THE INVENTION

The present invention has as its object to provide an optical system which has at least two optical components and which has a nearly athermal behavior, at reduced costs.

A further object of the invention is to provide an optical system, particularly a telescope, which has increased mechanical loading capacity with the smallest possible weight.

By the measure that a mounting includes compensation elements for a temperature-dependent change of a predetermined distance between a first and a second optical element, it is possible to compensate for a change of the position of the focal points of the optical elements due to thermal deformation by means of the mounting, in particular by means of the compensation elements. It is possible by means of the compensation elements to adapt the position of the second optical element to the new focal length of the first optical element, and vice versa. The optical system is thereby always optimally focused, independent of temperature.

It has been found to be advantageous to arrange the compensation elements parallel to an optical axis defined by the optical elements. The greatest possible length change of the position of the focal points of the optical elements in relation to the length extension of the compensation elements in the optical axis direction, per temperature interval, can thereby be attained.

The material used for the compensation elements is to be selected in dependence on the length of the compensation elements in the axial direction and in dependence on the focal point displacement per temperature interval, so that the length change of the compensation elements compensates for the displacement of the focal point.

In particular, it has been found to be advantageous to designate a material for the compensation elements which has a greater thermal expansion coefficient than the material of the mounting. It is thereby possible to attain a large length change in dependence on the temperature change.

It has been found to be advantageous to arrange the compensation elements in the region of the first optical element, in particular in the region of a primary mirror of a telescope, so that there is no, or nearly no, temperature difference between the first optical element, particularly the mirror member, and the compensation elements. Thereby the compensation elements undergo approximately the same temperature change as the first optical element.

It has been found to be advantageous to use for the mounting a material with a sufficient thermal conductance and very small expansion coefficients, so that when the mounting or the telescope tube is exposed to unilateral or unequal irradiation, a more rapid temperature equalization takes place and the deformations due to a temperature gradient remain small. In this manner, stresses in the mounting itself, and warping resulting from temperature gradients, due to a local expansion of the mounting and the components fixedly connected to the mounting, are avoided.

In particular, with a seating constituted in the shape of a star for a secondary mirror in a telescope, the result of a temperature gradient in the region of the seating of the secondary mirror is a bending of the seating, giving rise to defocusing.

In objectives or objective systems in semiconductor lithography, large troublesome effects arise from the smallest departure from adjustment, since extremely small structures are imaged. A system-specific adjustment of the compensation elements by the use of a material with a very small expansion coefficient for the mounting of the optical elements is facilitated, or even made possible for the first time, since then primarily only the influence of the material of the optical elements themselves has to be considered.

The production costs can be minimized by the measure, in optical systems with at least one mirror, of producing the mirror members from SiN; this is of particular interest for production in large numbers of items.

In particular, a replication process can be used for mirror manufacture when SiN is used, and aspheric mirrors can also thereby be produced at a favorable cost, which is of particular interest as regards use in lithographic objectives. In mirror manufacture by the replication process, very hard materials can be used which also can be brittle and unsuitable for polishing. Ceramic materials above all are possible here; besides having low weight, they also have low expansion coefficients.

It has been found to be advantageous to designate for the mounting of the material C/C SiC, the one with similar physical properties. C/C SiC is a carbon-fiber strengthened combined material that comprises silicon carbide. In particular, if the mounting includes a telescope tube, it has been found to be advantageous to make the telescope tube of C/C SiC.

Further advantageous measures are described in further dependent claims. As an embodiment example, a telescope and a schematically shown optical system are described.

### BRIEF DESCRIPTION OF THE DRAWINGS

FIG. 1 shows a telescope with a primary mirror produced by polishing technique and a mirror carrier of SiN;

FIG. 2 shows a telescope with a mirror member of SiN and a primary mirror produced by replication technique, and

FIG. 3 shows an optical system.

### DETAILED DESCRIPTION OF THE INVENTION

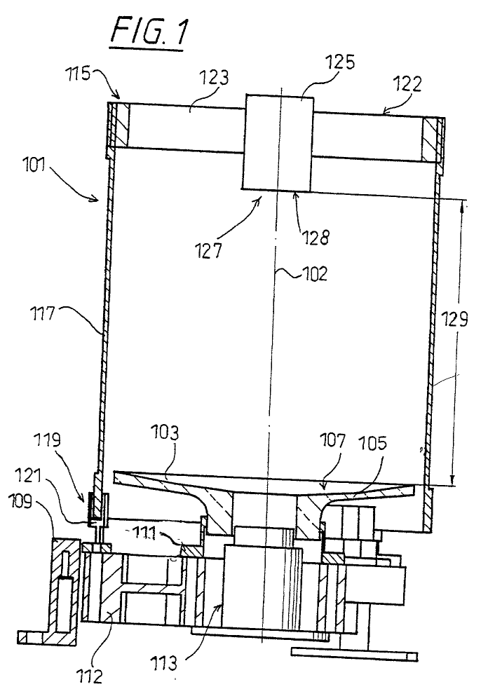

The principal structure of a telescope 1 is first described with reference to FIG. 1.

The telescope 101 shown has a primary mirror 103 and a secondary mirror 127, the mirror faces 107, 128 of which are arranged facing each other. An optical axis 102 is defined by these two mirrors 103, 127. These two mirrors are connected together by means of a mounting 115 [and compensation element 119], and are arranged at a predetermined distance 129 from each other.

In the embodiment example shown, the mounting 115 includes a telescope tube 117 arranged coaxially of the optical axis 102, and a seating 122 in the form of a holding star 123 for mounting the secondary mirror 127. The holding star 123 and the telescope tube 117 preferably consist of the identical material, to avoid stresses due to differing expansion coefficients of the materials. In the embodiment example shown, C/C SiC is provided as the material, and has a sufficient thermal conductance and very small expansion coefficients, so that in the mounting 115, temperature gradients and deformations can occur only briefly, if at all, due to a unilateral irradiation. A large quotient formed by dividing the thermal conductivity by the expansion coefficient is to be sought.

A mirror seating 125 for the secondary mirror 127 is connected to the holding star 123. Compensation elements 119 in the form of three feet 121, arranged at an angular spacing of 120°, are provided on the end of the telescope tube 117 remote from the secondary mirror 127. These feet 121 engage at one end around the end of the telescope tube 117 and at the other end are connected to a mirror mounting 111 of the primary mirror 103. A ring could also be provided as a compensation element, of a material which has a thermal expansion coefficient other than that of the mounting. It is crucial that the compensation element(s) has/have an extension in the direction of the optical axis 102.

The mirror mounting 111 is mounted on a mirror carrier 112, which in turn is isostatically received by the mounting elements 109. The mirror mounting 111 and also the primary mirror 103 are coaxial to a tube 113 arranged on the optical axis 102 and in its turn including a collimator.

In the embodiment shown, the primary mirror 103 includes a mirror member 105 of quartz glass, provided with a mirror surface by polishing technique. The mirror mounting 111 is of invar, and the mirror carrier 112 is of SiN. C/C SiC is provided for the mounting 115.

In this telescope 101, the radiation striking the primary mirror is deflected to the secondary mirror, this radiation thus being focused over the tube 113 by reflection at the secondary mirror 127.

On a heating of this telescope 101, particularly of the primary mirror 103, the focal length of the primary mirror 103 is displaced to greater distances. The distance 129 predetermined by the mounting 115 is increased by the compensation elements 119, which are likewise arranged in the region of the primary mirror 103, so that no displacement of the focal point takes place.

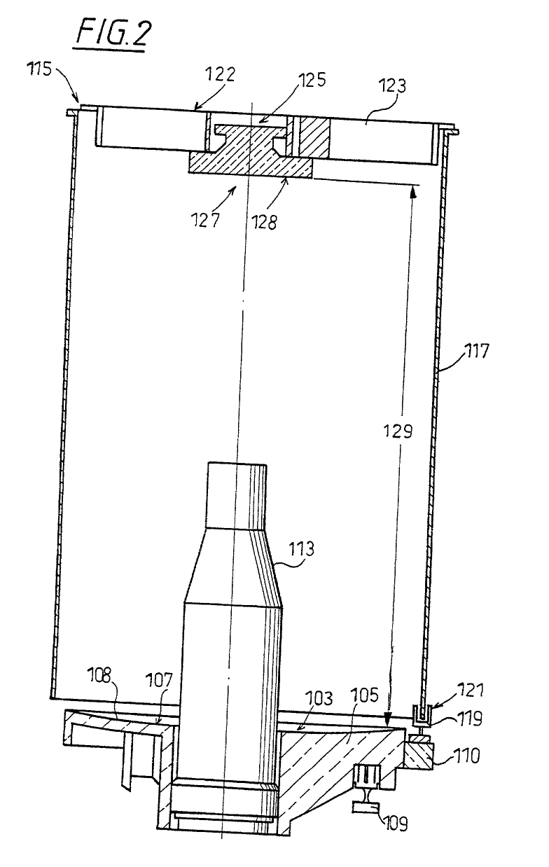

The embodiment example shown in FIG. 2 differs principally in the primary mirror 103. In this embodiment example, the primary mirror 103 was made by replication technique with a mirror member 105 of SiN.

In particular, aspheric mirror surfaces 108 can be produced at a favorable cost in replication technique. Very hard, and in some circumstances brittle, materials can also be used, which must not be polished. Such stiff materials generally have low thermal expansion coefficients. Because of the stiff material for the mirror member 105, no separate mirror mount 111 and no mirror carrier 112 are required, as in the embodiment example according to FIG. 1. From the stresses arising in the mirror member 105 in the replication technique, only very small deformations result due to the shrinkage of the replication resin.

The mirror member 105 is connected to mounting elements 109 by which it is received isostatically. The mirror member 105 is provided on its outer radius with projections 110 on which compensation elements 119, which are again constituted as feet, are supported by their ends. A ring of a material which has a thermal expansion coefficient other than that of the mounting 115 could also be provided as the compensation elements 119. In this embodiment example, the mounting 115 and the holding star 123 are of C/C SiC. It is crucial that the compensation element(s) 119 has/have an extension in the direction of the optical axis 102. The material for the compensation elements 119 is to be selected in dependence on the mirror member 5 used, where the material for the compensation elements is to be selected in dependence on their extension in the axial direction at a reference temperature, and in dependence on the focal point displacement to be expected per temperature change. The length change of the mounting 115 in the axial direction in dependence on temperature is also to be considered, so that this length change plus the length change of the compensation elements 119 gives the displacement of the focal point.

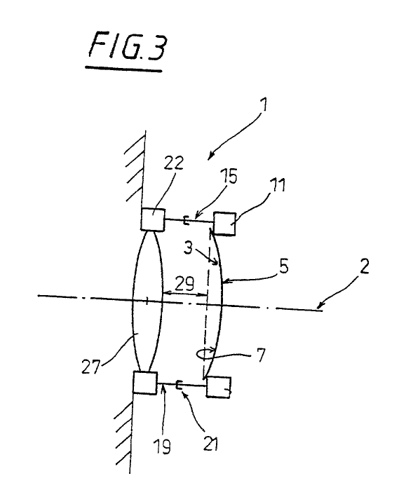

An optical system is shown in FIG. 3. This optical system includes a first optical element 3, here a mirror, which is mounted by a mirror mount 11, and a second optical element 27, here a lens, which is mounted by a mount 22. The mount 22 is in its turn fixedly supported. This lens could however also be movably supported. It is crucial that the optical system 1 formed by the optical elements 27 and 5 is almost athermalized. The mount 9″ is connected to the mount 22 via compensation elements 19 and a mounting 15. The changes in the optical properties, particularly the change of the focal length, are compensated by means of the compensation elements 19, as already described for the telescope.

List of Reference Numerals

| | | | |
|---|---|---|---|
| 1 | optical system | 115 | mounting |
| 2 | optical axis | 117 | telescope tube |
| 3 | first optical element | 119 | compensation element |
| 5 | mirror member | 121 | feet |
| 9 | mounting element | 122 | seating |
| 11 | mirror mount | 123 | holding star |
| 15 | mounting | 125 | mirror seating |
| 19 | compensation element | 127 | secondary mirror |
| 27 | second optical element | 128 | mirror surface |
| 29 | predetermined distance | 129 | predetermined distance |
| 101 | telescope | | |
| 102 | optical axis | | |
| 103 | primary mirror | | |
| 105 | mirror member | | |
| 107 | mirror (surface) | | |
| 108 | aspheric mirror | | |
| 109 | mounting element | | |
| 110 | projections | | |
| 111 | mirror mount (polishing technique) | | |
| 112 | mirror carrier | | |
| 113 | tube with collimator | | |

We claim:

1. An optical system, comprising
at least a first optical element and second optical element, the first optical element and the second optical element being arranged at a predetermined distance from each other by means of a mounting,
wherein the mounting (15,115) comprises compensation elements (19, 119) for a temperature-dependent change of the predetermined distance (29, 129) between the first optical element (3, 103) and the second optical element (27, 127), the mounting being produced from a material of density of at most 2.5×10³ kg/m³.

2. The optical system according to claim 1, wherein the first optical element (3, 103) and the second optical element (27, 127) comprise components of an objective for lithography.

3. The optical system according to claim 1, wherein at least one of the first optical element and the second optical element (3, 27) comprises a mirror.

4. The optical system comprising
a mirror comprising a mirror member carrying a surface, which mirror member is connected to a further optical element by means of a mounting (15, 115) and compensation elements (19, 119),
wherein with a mirror member comprising quartz, the compensation elements comprise at least partially titanium, and with a mirror member comprising SiN the compensation elements comprise at least partially aluminum or titanium, and with a mirror carrier comprising Zerodur the compensation elements comprise at least partially invar.

5. The optical system according to claim 1, wherein at least one of the optical elements comprises a lens.

6. The optical system according to claim 1, wherein the optical system comprises a telescope, the first optical element comprises a primary mirror (103) of the telescope (101) and the second optical element comprises a secondary mirror (127) of the telescope (101).

7. The optical system according to claim 4, wherein the mounting comprises a material of density of at most 2.5×10³ kg/m³.

8. The optical system according to claim 1, wherein the compensation elements (19, 119) are arranged in a region of at least one of the optical elements (3, 27, 103, 127), coaxially of an optical axis (2, 102) defined by the optical elements (3, 27, 103, 127).

9. The optical system according to claim 6, wherein the compensation elements (119) are arranged coaxially of the primary mirror (103).

10. The optical system according to claim 6, wherein the mounting comprises a telescope tube comprising an end facing the primary mirror and an end facing the secondary mirror, wherein the compensation element (119) comprises at least three feet (121) that at one end carry an end of the telescope tube (17) facing the primary mirror (103), and at another end are connected to the primary mirror (103).

11. The optical system according to claim 10, wherein the compensation elements are supported on a mirror carrier (105) carrying the mirror surface (107) of the primary mirror (103).

12. The optical system according to claim 1, wherein the compensation elements (19, 119) have a thermal expansion coefficient deviating from that of the mounting (15, 115).

13. The optical system according to claim 3, wherein the mirror (3, 103) comprises a mirror member (5) comprising SiN carrying a mirror surface (7, 107).

14. The optical system according to claim 1, wherein the mounting (15, 115) comprises C/C SiC material.

15. The optical system according to claim 3, wherein the mirror (3, 103) comprises a mirror produced by replication technique.

16. The optical system according to claim 13, wherein the mirror member (5, 105) is connected directly to a mounting element (9, 109) for isostatic mounting, and the mounting (15, 115) is mounted to the mirror member (5, 105).
